(19) United States
(12) Patent Application Publication
(10) Pub. No.: US 2025/0260103 A1
(43) Pub. Date: Aug. 14, 2025

(54) BATTERY MODULE INCLUDING SEALING PORTION

(71) Applicant: SK On Co., Ltd., Seoul (KR)

(72) Inventors: Jeong Woo HAN, Daejeon (KR); Sang Tae AN, Daejeon (KR); Soo Hyun YOU, Daejeon (KR)

(21) Appl. No.: 19/050,117

(22) Filed: Feb. 11, 2025

(30) Foreign Application Priority Data
Feb. 14, 2024 (KR) 10-2024-0021217

(51) Int. Cl. H01M 50/186; H01M 50/184; H01M 50/383

(52) U.S. Cl. CPC H01M 50/186; H01M 50/184; H01M 50/383

(57) ABSTRACT

A battery module includes a first sub-module and a second sub-module respectively including a cell assembly formed by stacking a plurality of battery cells and a protective cover accommodating at least a portion of the cell assembly, and facing each other in a first direction, and a sealing portion provided on the protective cover and disposed on at least a portion of a peripheral surface of the protective cover. The sealing portion is formed by a plurality of sealing components separable based on the peripheral surface of the protective cover.

### CROSS-REFERENCE TO RELATED APPLICATION(S)

This patent document claims the priority and benefits of Korean Patent Application No. 10-2024-0021217 filed on Feb. 14, 2024, the disclosure of which is incorporated herein by reference in its entirety.

### TECHNICAL FIELD

The disclosure and implementations disclosed in this patent document generally relate to a battery module including a sealing portion.

### BACKGROUND

Secondary batteries, unlike primary batteries, have the convenience of being able to be charged and discharged, and are thus receiving significant attention as power sources for various mobile devices and electric vehicles.

These secondary batteries may include battery cells in which an electrode assembly formed by stacking or winding positive electrode plates, negative electrode plates, and separators in a roll shape is accommodated in a case.

A plurality of battery cells may be stacked in a predetermined direction and accommodated in a battery module. A plurality of battery modules may be connected in series/parallel and aligned in a predetermined array to form a battery pack.

Meanwhile, a battery cell may experience thermal runaway, in which gas and flames are generated, due to internal short circuits, overcharge, or the like. In this case, a flame may occur in the trigger module that accommodates the battery cell, and the flame may spread to an adjacent battery module, causing a fire in the adjacent battery module, which may result in thermal propagation.

Accordingly, there is a need for a structure sealing the interior to significantly delay or prevent flames generated in a battery module from spreading to adjacent battery modules as much as possible.

### SUMMARY

The present disclosure may be implemented in some embodiments to provide a battery module in which a fire originating in a battery module may be delayed or significantly reduced from spreading to adjacent battery modules.

In a battery module according to an aspect of the present disclosure, a fire occurring in one sub-module may be delayed or significantly reduced from spreading to an adjacent sub-module.

A battery module according to an aspect of the present disclosure may be widely applied to devices within green technology fields such as electric vehicles, battery charging stations, and other solar power generation and wind power generation using batteries. In addition, a battery module according to an aspect of the present disclosure may be used in eco-friendly electric vehicles, hybrid vehicles, and the like to prevent climate change by suppressing air pollution and greenhouse gas emissions.

In some embodiments of the present disclosure, a battery module includes a first sub-module and a second sub-module respectively including a cell assembly formed by stacking a plurality of battery cells and a protective cover accommodating at least a portion of the cell assembly, and facing each other in a first direction; and a sealing portion provided on the protective cover and disposed on at least a portion of a peripheral surface of the protective cover. The sealing portion is formed by a plurality of sealing components separable based on the peripheral surface of the protective cover.

The protective cover may include a center cover disposed close to a cell assembly adjacent thereto; an end cover facing the center cover; and a side cover disposed parallel to a stacking direction of the plurality of battery cells, and the sealing portion may be provided to surround at least one of the center cover, the end cover, or the side cover.

The battery module may further include an upper cover and a lower cover facing each other in a second direction perpendicular to the first direction, with the first sub-module and the second sub-module interposed therebetween, and respectively coupled to the protective cover. The upper cover and the lower cover may be coupled to the end cover, the center cover, and the side cover and may be disposed on the first sub-module and the second sub-module.

The plurality of sealing components may include a first component provided on the upper cover and disposed to face the center cover; a second component provided on the lower cover and disposed to face the center cover; and a third component provided on the side cover and disposed to face the center cover. The upper cover, the lower cover, and the side cover may be coupled to the center cover.

The first component, the second component, and the third component may form a sealing portion disposed to surround a peripheral surface of the center cover when the upper cover, the lower cover, and the side cover are coupled to the center cover.

The end cover may have a chamfer formed at each corner, and the sealing portion may include a chamfer component provided in a shape corresponding to the chamfer.

The chamfer component may be provided on both ends of at least one of the first component, the second component, or the third component.

The upper cover and the lower cover may be provided with the first component and the second component disposed on portions thereof overlapping with distal ends of one sides of the center cover and the side cover, based on the second direction. The side cover may be provided with the third component provided on the distal end of one side thereof overlapping with the center cover based on the stacking direction.

The protective cover may be provided with a sealing groove accommodating at least a portion of the sealing portion.

In some embodiments of the present disclosure, a battery module includes a first sub-module and a second sub-module respectively including a cell assembly in which a plurality of battery cells are stacked in a first direction, a side cover facing the cell assembly in the first direction, and a center cover facing the cell assembly in a second direction perpendicular to the first direction; an upper cover and a lower cover disposed with the first sub-module and the second sub-module interposed therebetween in a direction perpendicular to the first direction and the second direction; and a plurality of sealing components provided on the side cover, the upper cover and the lower cover to face the center cover. The plurality of sealing components form a sealing portion disposed to surround at least a portion of the center cover in a direction perpendicular to the first direction when the side cover, the upper cover, and the lower cover are coupled to the center cover.

The sealing portion may be disposed between a distal end of one side of the side cover, the upper cover, the lower cover, and the center cover.

The center cover may be disposed between the cell assembly of the first sub-module and the cell assembly of the second sub-module.

The above-described solution in the present disclosure is illustrative, and it should be understood that other configurations that are not mentioned are included in the present disclosure even if they are added.

### BRIEF DESCRIPTION OF DRAWINGS

Certain aspects, features, and advantages of the present disclosure are illustrated by the following detailed description with reference to the accompanying drawings.

FIG. 1 is a perspective view of a battery module according to an embodiment.

FIG. 2 is an exploded perspective view of a battery module according to an embodiment.

FIG. 3 is an exploded perspective view of a sub-module according to an embodiment.

FIGS. 4A and 4B are cross-sectional views schematically illustrating flame propagation to adjacent sub-modules.

FIGS. 5A and 5B are cross-sectional views schematically illustrating flame propagation prevention to adjacent sub-modules according to an embodiment.

FIG. 6 is a drawing illustrating assembly of a sealing portion according to an embodiment.

FIG. 7 is a cross-sectional view schematically illustrating assembly of a sub-module according to an embodiment.

FIG. 8 is a cross-sectional view schematically illustrating assembly of a sealing portion according to another embodiment.

FIG. 9 is a cross-sectional view schematically illustrating assembly of a sealing portion according to another embodiment.

### DETAILED DESCRIPTION

Features of the present disclosure disclosed in this patent document are described by example embodiments with reference to the accompanying drawings.

Prior to the detailed description of example embodiments, terms or words used in the descriptions below and claims should not be construed as being limited to their usual or dictionary meanings, and should be interpreted with meaning and concept consistent with the technical idea of the present disclosure, based on the principle that the inventor may appropriately define the concept of terms to explain his or her invention in the best way.

The same reference numbers or symbols in respective drawings indicate parts or components performing substantially the same function.

In the following description, singular expressions include plural expressions unless the context clearly dictates otherwise. Terms such as “include,” “configure” and the like are intended to designate the presence of features, numbers, steps, operations, components, parts, or combinations thereof described in the specification, and should be understood as not precluding the presence or addition of one or more other features, numbers, steps, operations, components, parts, or combinations thereof.

In addition, in the following description, expressions such as upper side, upper portion, lower, bottom, side, front, rear, and the like are expressed based on the direction illustrated in the drawing, and it should be noted in advance that if the direction of the object is changed, it may be expressed differently.

Additionally, in the descriptions below and claims, terms including ordinal numbers such as “first,” “second,” and the like may be used to distinguish between components. These ordinal numbers are used to distinguish identical or similar components from each other, and the meaning of the term should not be interpreted limitedly due to the use of these ordinal numbers. For example, components combined with these ordinal numbers should not be interpreted as having a limited order of use or arrangement based on the number. If necessary, respective ordinal numbers may be used interchangeably.

Hereinafter, the present disclosure will be described in detail with reference to the attached drawings. However, this is merely illustrative and the present disclosure is not limited to the detailed embodiments described as examples.

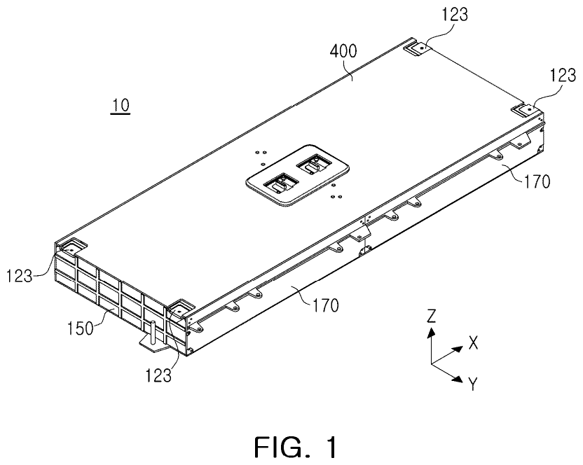

First, a battery module of the present disclosure will be described with reference to FIGS. 1 to 3.

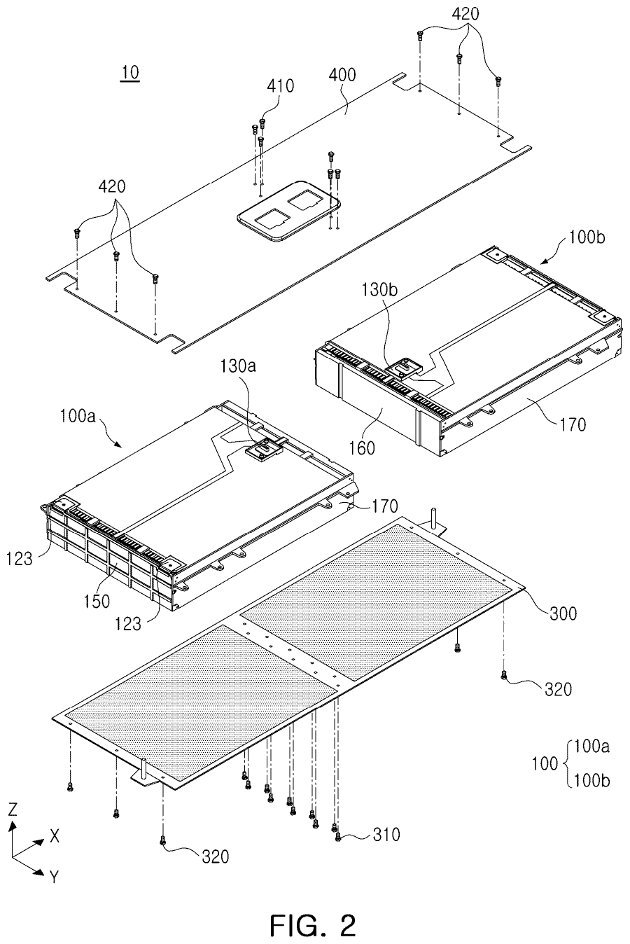

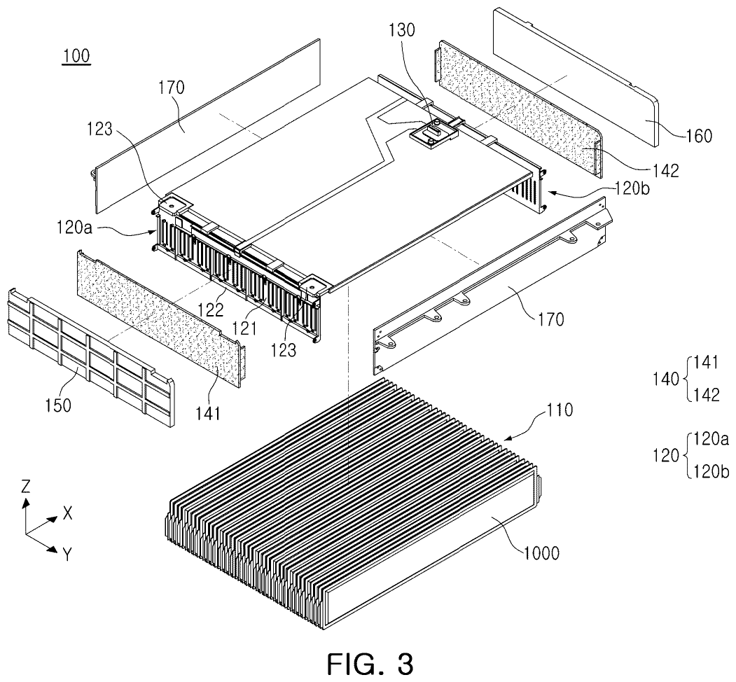

FIG. 1 is a perspective view of a battery module according to an embodiment, FIG. 2 is an exploded perspective view of a battery module according to an embodiment, and FIG. 3 is an exploded perspective view of a sub-module according to an embodiment. FIGS. 1 to 3 are merely example illustrations of the structure and shape of the sub-module 100 and the battery module 10, and it should be understood that the detailed shape of each component thereof is not limited to the drawings.

A battery module 10 may include a plurality of sub-modules 100. For example, the plurality of sub-modules 100 may be configured by assembling a first sub-module 100a and a second sub-module 100b along one direction (the X-axis direction in the drawings) to form one battery module 10. However, the battery module 10 is not limited to this structure and may include three or more sub-modules 100.

In the following description, a direction parallel to the direction in which the first sub-module 100a and the second sub-module 100b face each other is referred to as the first direction.

The first sub-module 100a and the second sub-module 100b included in the battery module 10 may have the same structure. For example, after manufacturing a plurality of sub-modules 100 of the same type, the sub-modules may be assembled together to form the entire battery module 10.

For example, in the following description, ‘the first sub-module 100a’ and ‘the second sub-module 100b’ only mean one and the other of the two sub-modules 100 assembled together, and both may be understood as sub-modules 100 having the same structure. In addition, ‘sub-module 100’ may be understood to mean one of the ‘first sub-module 100a’ and ‘second sub-module 100b’ described above.

The battery module 10 may include a lower cover 300 and an upper cover 400 supporting a plurality of sub-modules 100. One integrally formed lower cover 300 may be disposed to cover the lower surfaces of the plurality of sub-modules 100. Alternatively, one integrally formed upper cover 400 may be disposed to cover the upper surfaces of the plurality of sub-modules 100.

However, the structures of the lower cover 300 and the upper cover 400 are not limited to those described above. For example, a plurality of lower covers or a plurality of upper covers may be provided to cover a plurality of sub-modules 100, respectively, and the plurality of lower covers may be mutually combined to form a single structure.

A sub-module 100 may include a cell assembly 110 including battery cells 1000 stacked in one direction and a plurality of protective covers 150, 160 and 170 protecting the cell assembly 110.

The cell assembly 110 may include a plurality of battery cells 1000 that are stacked side by side. The stacking direction of the plurality of battery cells 1000 and the direction in which the sub-modules 100 are disposed may be perpendicular to each other. For example, the sub-modules 100 may be disposed in a first direction (X-axis direction) on the upper surface of the lower cover 300, and the battery cells 1000 included in each sub-module 100 may be stacked in a second direction (for example, Y-axis direction) that is perpendicular to the first direction (X-axis direction). In the following description, the ‘second direction’ may be understood as the stacking direction of the battery cells 1000.

The plurality of battery cells 1000 may be configured to convert chemical energy into electrical energy to supply power to an external circuit, or to receive power from the outside and energy convert electrical into chemical energy to store electricity. For example, the battery cell 1000 may be composed of a nickel metal hydride (Ni-MH) battery or a lithium ion (Li-ion) battery that may be charged and discharged.

A plurality of battery cells 1000 may be respectively provided by accommodating an electrode assembly (not illustrated) formed by stacking a positive electrode plate (cathode plate) and a negative electrode plate (anode plate). The electrode assembly may be configured in a form in which the positive electrode plates and the negative electrode plates are stacked with a separator interposed therebetween so that wide surfaces thereof face each other. The separator may be configured to prevent electrical short-circuiting between the positive electrode plate and the negative electrode plate and to allow ion flow. As an example, the separator may include a porous polymer film or a porous nonwoven fabric.

In addition, the electrode assembly may be accommodated in a case in various ways, such as a stacking type, a zigzag folding type (Z-folding type), a stack-folding type, or the like, in a jelly roll type formed by winding in a predetermined direction.

The plurality of battery cells 1000 may be pouch-type, prismatic-type, or cylindrical-type secondary batteries depending on the structure of the case. In an embodiment, each of the plurality of battery cells 1000 may be provided in a pouch type, and may be connected in series or in parallel while being stacked side by side to form one cell assembly 110.

The protective covers 150, 160 and 170 may include an end cover 150 and a center cover 160 that cover at least one side and the other side of the cell assembly 110, and a plurality of side covers 170.

The end cover 150 and the center cover 160 may be disposed to be spaced apart from each other in the first direction (X-axis direction), and the cell assembly 110 may be disposed between the end cover 150 and the center cover 160. The end cover 150 may be disposed adjacent to the side where a terminal portion 123 is disposed in the sub-module 100, and the center cover 160 may be disposed adjacent to the side where a sub-sensing module 130 is disposed in the sub-module 100.

The side cover 170 may be disposed to face the wide surface of the battery cell 1000 to protect the side surface of the cell assembly 110.

The end cover 150, the center cover 160, and the side cover 170 may be formed of a material (for example, a metal material such as aluminum or SUS) that has sufficient rigidity to protect the sub-module 100 from external impact.

The side cover 170 may be connected to the end cover 150 and the center cover 160, respectively. For example, a fastening member (not illustrated) may penetrate the side cover 170 and be fastened to the end cover 150 or the center cover 160. Alternatively, the side cover 170 may be mutually joined and fixed to the end cover 150 and the center cover 160 without a separate fastening member. In this case, a bonding method may use welding, but is not limited thereto.

Meanwhile, the side cover 170 may also be coupled to a bus bar frame 122 disposed on the inner side of the end cover 150 and the center cover 160.

The end cover 150, the center cover 160, and the side cover 170 are firmly coupled to each other so that the sub-module 100 may have structural stability.

The sub-module 100 may further include a busbar assembly 120 electrically connected to the cell assembly 110, and an insulating cover 140 coupled to the busbar assembly 120.

The busbar assembly 120 may include a plurality of conductive members (busbars, 121) electrically connected to the battery cells 1000, and a busbar frame 122 supporting the busbars 121. Some of the plurality of busbars 121 may be connected to a terminal portion 123 that may be connected to an external electrical circuit. The terminal portion 123 may include a positive electrode terminal and a negative electrode terminal.

Referring to FIG. 3, the busbar assembly 120 may include a first busbar assembly 120a disposed on one side of the cell assembly 110 and a second busbar assembly 120b disposed on the other side of the cell assembly 110. One of the first busbar assembly 120a and the second busbar assembly 120b may have a pair of terminal portions 123 disposed, and the other thereof may not have a terminal portion 123. For example, the first busbar assembly 120a having a pair of terminal portions 123 may be disposed between the end cover 150 and the cell assembly 110, and the second busbar assembly 120b not having a terminal portion 123 may be disposed between the center cover 160 and the cell assembly 110. The terminal portion 123 of the first busbar assembly 120a may be disposed adjacent to the end cover 150 and exposed to the outside of the battery module 10. According to this structure, the terminal portions 123 may be disposed spaced apart in the second direction (Y-axis direction) along one edge of the sub-module 100.

A first insulating cover 141 may be disposed between the first busbar assembly 120a and the end cover 150, and a second insulating cover 142 may be disposed between the second busbar assembly 120b and the center cover 160. The first insulating cover 141 and the second insulating cover 142 may be coupled to the first busbar assembly 120a and the second busbar assembly 120b, respectively. The first insulating cover 141 and the second insulating cover 142 may include an insulating material to prevent the end cover 150 and the center cover 160 from being electrically short-circuited with the busbar 121.

The terminal portion 123 may be disposed adjacent to one edge of the sub-module 100. For example, the terminal portion 123 may be disposed in the first bus bar assembly 120a disposed between the end cover 150 and the cell assembly 110. For example, the terminal portion 123 included in each sub-module 100 may be disposed on the outer side of the battery module 10.

In addition, the first sub-module 100a and the second sub-module 100b may be assembled so that the center covers 160 face each other.

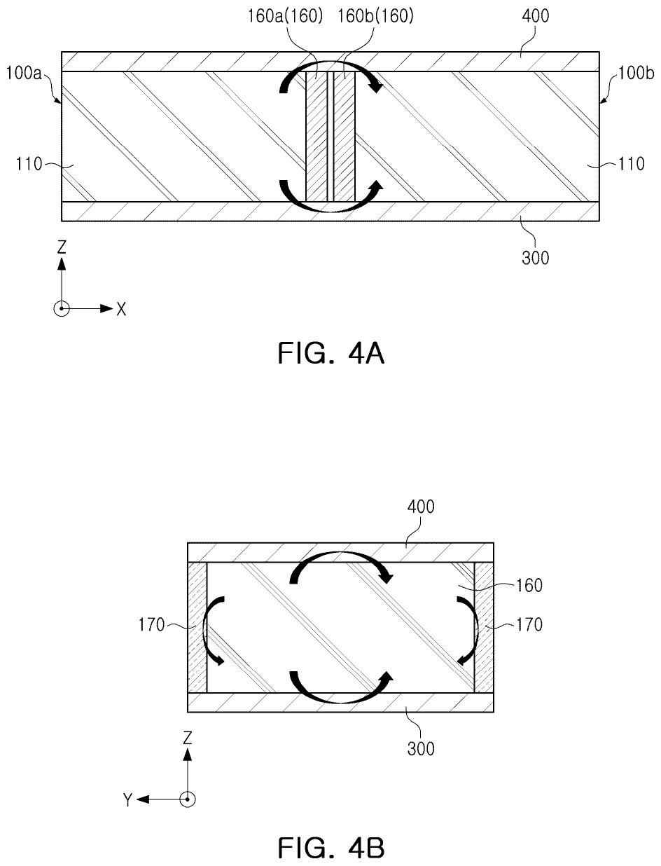

In the drawing, the first sub-module 100a and the second sub-module 100b are illustrated as including the center covers 160a and 160b, respectively (see FIG. 4A), but the present disclosure is not limited thereto, and may be provided with a structure in which one center cover 160 is disposed between the first sub-module 100a and the second sub-module 100b.

In detail, as one center cover 160 is disposed between the cell assembly 110 of the first sub-module 100a and the cell assembly 110 of the second sub-module, the first sub-module 100a and the second sub-module 100b may share one center cover 160 with each other.

In the process of assembling the two sub-modules 100, the side covers 170 included in respective sub-modules 100 may be joined to each other. For example, the side cover 170 of the first sub-module 100a and the side cover 170 of the second sub-module 100b may be joined to each other while facing each other in the first direction (X-axis direction). The joining of the side cover 170 of the first sub-module 100a and the side cover 170 of the second sub-module 100b may be performed by welding, but is not limited thereto.

The upper and lower portions of the first sub-module 100a and the second sub-module 100b may be covered by the upper cover 400 and the lower cover 300, respectively.

The lower cover 300 may be coupled to the first sub-module 100a and the second sub-module 100b. For example, a fastening member 310 may be fastened to the center cover 160 by penetrating through the lower cover 300, and thus the first sub-module 100a and the second sub-module 100b may be fixed to the lower cover 300. In addition, another fastening member 320 may be fastened to the end cover 150 by penetrating through the lower cover 300.

The upper cover 400 may be coupled to the first sub-module 100a and the second sub-module 100b. For example, a fastening member 410 may be fastened to the center cover 160 by penetrating the upper cover 400, and thus the first sub-module 100a and the second sub-module 100b may be fixed to the lower cover 300. In addition, another fastening member 420 may be fastened to the end cover 150 by penetrating the upper cover 400.

In a state where the upper cover 400 and the lower cover 300 are coupled to the sub-modules 100, the end cover 150 of the sub-module 100 may be disposed adjacent to one edge of the upper cover 400 and the lower cover 300. In addition, the center cover 160 may be disposed in the first direction (X-axis direction) central region of the upper cover 400 and the lower cover 300.

The lower cover 300 and the upper cover 400 may be respectively joined to the side cover 170 of the sub-module 100. For example, in a state where the sub-modules 100 are secured to the lower cover 300, the side covers 170 may be in contact with the lower cover 300 and may be mutually joined along the contacted portion. Likewise, when the upper cover 400 is disposed on the upper portion of the sub-module 100, the side covers 170 may be in contact with the upper cover 400 and may be mutually joined along the contacted portion.

In this manner, the upper cover 400 and the lower cover 300 may be combined with the sub-modules 100 to form the entire battery module 10.

In the battery module 10, the end cover 150 and the side cover 170 of each sub-module 100 may be exposed to the outside of the battery module 10. For example, the upper surface of the battery module 10 may be formed by the upper cover 400, the lower surface thereof may be formed by the lower cover 300, and the side surface thereof may be formed by the end cover 150 and the side cover 170. In this case, the center covers 160 of respective sub-modules 100 face each other inside the battery module 10 and may not be exposed to the outside of the battery module 10 by being covered by the upper cover 400, the lower cover 300, and the side cover 170.

In this manner, the battery module 10 according to an embodiment of the present disclosure may include a plurality of sub-modules 100. The plurality of sub-modules 100 have the advantage of improving the efficiency of the assembly process and energy efficiency by simplifying the connection and assembly relationship between the sub-modules 100.

However, if a flame occurs in one of the plurality of sub-modules 100 and becomes a so-called trigger sub-module, the trigger sub-module may be vulnerable to heat propagation in which heat and flame are propagated to the adjacent sub-module 100.

FIGS. 4A and 4B are cross-sectional views schematically illustrating flame propagation to adjacent sub-modules. FIGS. 4A and 4B illustrate that the first sub-module 100a functions as a trigger sub-module by way of example.

The flame may pass through the gap between any two of the plurality of protective covers 150, 160 and 170, the upper cover 400, and the lower cover 300.

Referring to the arrows in FIGS. 4A and 4B, when a fire occurs in the cell assembly 110 of the first sub-module 100a, it can be seen that the flame spreads toward the second sub-module 100b through the gap between at least one of the upper cover 400, the lower cover 300 and the side cover 170, and the center cover 160. In this manner, since the first sub-module 100a and the second sub-module 100b are assembled adjacently, if a fire occurs in one sub-module 100, the heat and flames may be relatively easily propagated to the other sub-module 100.

Meanwhile, FIG. 4A and FIG. 4B is an example illustrating the propagation of flames, and as described above, a flame occurring in one sub-module 100 may be discharged through a gap between at least two adjacent members among the end cover 150, the center cover 160, the side cover 170, the upper cover 400, and the lower cover 300. In this case, unlike FIG. 4A and FIG. 4B, there is a risk of fire spreading between the battery module 10 and the adjacent other battery module 10.

Accordingly, according to an embodiment of the present disclosure, a sealing portion 200 is provided in the protective covers 150, 160 and 170, so that a flame generated in one sub-module 100 among the plurality of sub-modules 100 may be prevented from spreading to another sub-module 100 or an adjacent battery module 10.

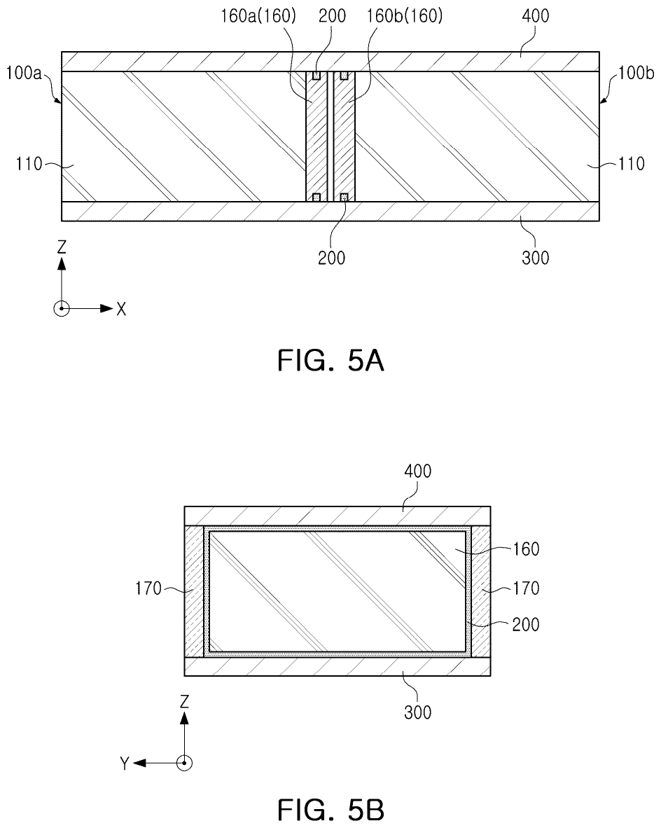

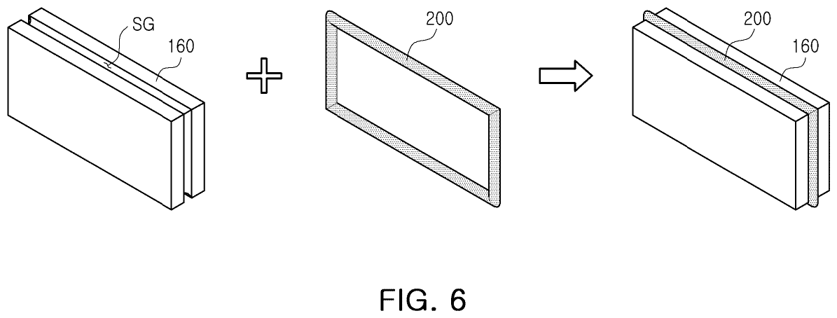

FIGS. 5A and 5B are cross-sectional views schematically illustrating prevention of flame from spreading to an adjacent sub-module according to an embodiment. FIG. 6 is a drawing illustrating assembly of a sealing portion according to an embodiment.

Referring to FIGS. 5A, 5B and 6, the battery module 10 according to an embodiment the present disclosure may further include a sealing portion 200 disposed to surround the protective covers 150, 160 and 170, to block a gap between the protective covers 150, 160 and 170 and at least one of the upper cover 400 or the lower cover 300.

The sealing portion 200 may include an elastic material to seal the gap. In addition, the sealing portion 200 may include a heat-resistant material to be prevented from being deformed or melted by heat of the flame generated from the battery cell 1000.

Hereinafter, the structure of the sealing portion 200 of the present disclosure will be described with reference to the drawings. Meanwhile, for the convenience of understanding, the sealing portion 200 is described as being provided while surrounding the center cover 160, but may also be provided in the end cover 150 and the side cover 170, of course.

Referring to FIGS. 5A and 5B, the battery module 10 according to an embodiment of the present disclosure may be provided with a sealing portion 200 on a center cover 160 of at least one of a plurality of sub-modules 100.

The sealing portion 200 may be disposed between members adjacent to the center cover 160, for example, the side cover 170, the upper cover 400 and the lower cover 300, and the center cover 160. Therefore, flames may be prevented from spreading through the gap between the center cover 160 and the adjacent members.

Referring to FIG. 6, the battery module 10 according to an embodiment of the present disclosure may be provided with a sealing groove SG into which the sealing portion 200 may be at least partially inserted, in a portion thereof where the sealing portion 200 is disposed. For example, the sealing groove SG may be formed while surrounding the edge surface of the center cover 160, and the sealing portion 200 may be disposed to surround the center cover 160 while being inserted into the sealing groove SG.

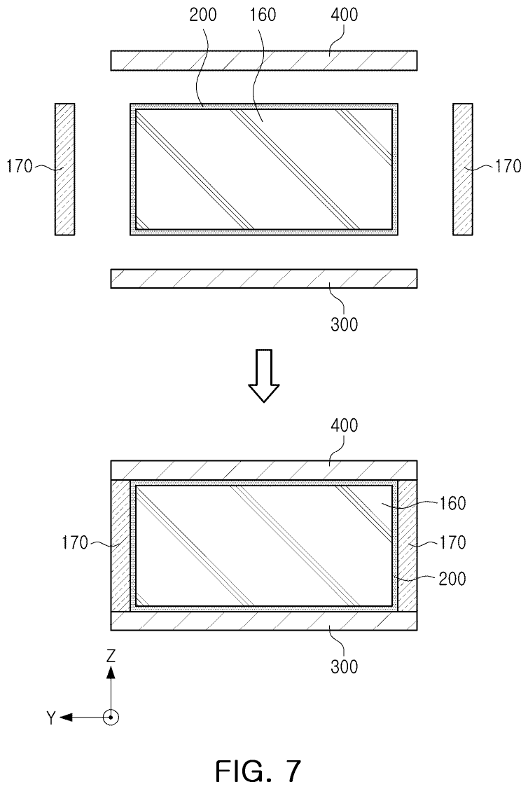

FIG. 7 is a cross-sectional view schematically illustrating the assembly of a sub-module according to an embodiment. Referring to FIG. 7, the battery module 10 of the present disclosure may be provided in which the upper cover 400, the lower cover 300, and the side cover 170 are coupled to the center cover 160 having the sealing portion 200 provided thereon.

Meanwhile, when assembling adjacent parts while the sealing portion 200 is disposed on an assembled body, for example, the center cover 160 as illustrated in FIG. 7, a gap may be created or assembly may be difficult even after the assembly is completed, due to deformation of the sealing portion 200 during the assembly process, assembly tolerance, or the like.

For example, when the side cover 170 fastens the center cover 160 to the upper cover 400 or the lower cover 300 by the fastening member 310 or 410, the sealing portion 200 may be partially deformed by elasticity due to the fastening force between the side cover 170 and the center cover 160. In this state, when the upper cover 400 and the lower cover 300 are combined, the cover part that is combined last may be difficult to combine due to the deformation of the sealing portion 200, or the sealing portion 200 may deviate from a preset position and not be able to completely close the gap.

Accordingly, according to another embodiment of the present disclosure described below, a sealing portion 200 may include a plurality of sealing components 201, 202 and 203 that are coupled to adjacent cover members.

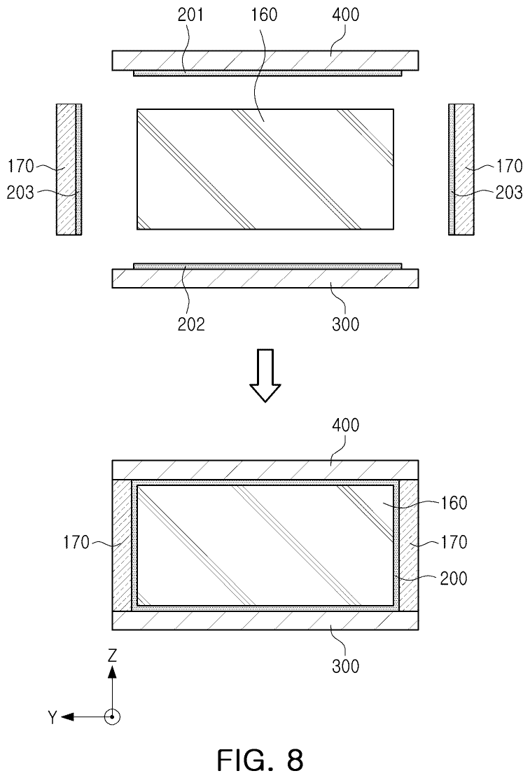

FIG. 8 is a cross-sectional view schematically illustrating the assembly of the sealing portion according to another embodiment. Referring to FIG. 8, adjacent cover members equipped with the sealing components 201, 202 and 203 may be combined to form a single sealing portion 200.

In detail, a battery module 10 according to an embodiment may include a cell assembly 110a formed by stacking a plurality of battery cells, and protective covers 150, 160 and 170 that accommodate at least a portion of the cell assembly 110a, and may include a first sub-module 100a and a second sub-module 100b facing each other in a first direction and a sealing portion 200 provided on the protective covers 150, 160 and 170 to surround the peripheral surfaces of the protective covers 150, 160 and 170. In this case, the sealing portion 200 may be formed of a plurality of sealing components 201, 202 and 203 that may be separated based on the peripheral surface of the protective covers 150, 160 and 170.

Meanwhile, in this specification, the “peripheral surface of the protective cover 150, 160, 170” may mean a surface through which a fluid such as gas passes, and in detail, may mean at least one surface that faces respective components of the protective covers 150, 160 and 170 and does not face the cell assembly 110a.

For example, the “peripheral surface of the protective cover 150, 160, 170” may mean the peripheral surface of at least one of the end cover 150, the center cover 160, or the side cover 170.

In this case, the “peripheral surface of the end cover 150” may refer to at least one of the upper surface, the lower surface (the surface facing the Z-axis direction), or the side surface (the surface facing the Y-axis direction) of the end cover 150. In addition, the “peripheral surface of the center cover 160” may refer to at least one of the upper surface, the lower surface (the surface facing the Z-axis direction), or the side surface (the surface facing the Y-axis direction) of the center cover 160. In addition, the “peripheral surface of the side cover 170” may refer to at least one of the upper surface, the lower surface (the surface facing the Z-axis direction), or the side surface (the surface facing the X-axis direction) of the side cover 170.

For example, the “peripheral surface of the protective cover 150, 160, 170” may mean at least one surface (a portion) of the circumference surfaces of the protective covers 150, 160 and 170 described above.

The sealing portion 200 may include a plurality of sealing components 201, 202 and 203 provided on other cover members adjacent to the assembly body.

The plurality of sealing components 201, 202 and 203 may include a first component 201 provided on the upper cover 400, a second component 202 provided on the lower cover 300, and a third component 203 provided on the side cover 170.

Through this structure, the plurality of sealing components 201, 202 and 203 may form a sealing portion 200 that is disposed on the center cover 160 in a direction perpendicular to the first direction when the side cover 170, the upper cover 400, and the lower cover 300 are combined with the protective covers 150, 160 and 170, in detail, the center cover 160.

In this case, the sealing portion 200 may be disposed on at least a portion of the peripheral surface of the center cover 160. For example, the sealing portion 200 may be disposed to wrap at least a portion of the center cover 160. In this specification, ‘wrap’ does not mean enclosing all parts of the peripheral surface of the center cover 160, but rather means being disposed on at least partial surface (a portion) of the peripheral surface of the center cover 160.

In detail, if the sealing portion 200 is positioned at a position where it may at least partially block the flow of fluid flowing in the gap between the components of the protective covers 150, 160 and 170, it may be referred to as the sealing portion 200 of the present disclosure, and it does not necessarily have to be positioned to surround the entire circumference. Meanwhile, in the drawing, the plurality of sealing components 201, 202 and 203 are illustrated as having a total of four, including one first component 201 and one second component 202, and two third components 203, but the present disclosure is not limited thereto. For example, the number of the plurality of sealing components 201, 202 and 203 may correspond to the number of circumferences of the assembly (center cover; 160 in the drawing).

For example, if the upper cover 400 and the lower cover 300 are not combined with the center cover 160, the sealing portion 200 may be provided as two third components. In addition, although each sealing component is provided in a straight line shape in the drawing, the present disclosure is not limited thereto, and one of the plurality of sealing components may be provided in a “[” shape and the other may be provided in an “l” shape. In addition, at least one of the plurality of sealing components may be provided in an shape and may be respectively disposed on two sides of the center cover 160.

For example, if the sealing portion 200 of the present disclosure includes two or more sealing components that are separable from each other, it may be said that they all belong to the present disclosure.

In addition, when the sealing portion 200 is formed of a plurality of separable sealing components 201, 202 and 203, it should be understood that it is included in the present disclosure even if the sealing portion is provided to surround at least a portion of the circumferences of the protective covers 150, 160 and 170. For example, it is sufficient even if at least one of the first component, the second component, or the third component is only disposed on a portion of the circumference of the center cover 160.

The upper drawing of FIG. 8 illustrates the state before the cover members (side cover; 170, upper cover; 400, lower cover; 300) adjacent to the center cover 160 are assembled. At this time, the sealing portion 200 is provided in a state where the plurality of sealing components 201, 202 and 203 are separated.

The lower drawing of FIG. 8 illustrates the state in which the aforementioned adjacent cover members are assembled to the center cover 160. At this time, a plurality of sealing components 201, 202 and 203 may form a single sealing portion 200 by surrounding the periphery of the center cover 160. The plurality of sealing components 201, 202 and 203 may form the sealing portion 200 only when adjacent cover members are assembled. For example, the sealing portion 200 may be formed only when the battery module 10 is assembled and the adjacent cover members and the center cover 160 are combined, and when the cover members are separated, the sealing portion 200 may be separated into a plurality of sealing components 201, 202 and 203. Accordingly, the sealing portion 200 may also be referred to as a sealing component assembly formed by assembling multiple sealing components.

Through this structure, deformation of the sealing portion 200 during the assembly process of the battery module 10 may be prevented significantly, and the problem of cover members being difficult to assemble due to assembly tolerance during the assembly process may be reduced.

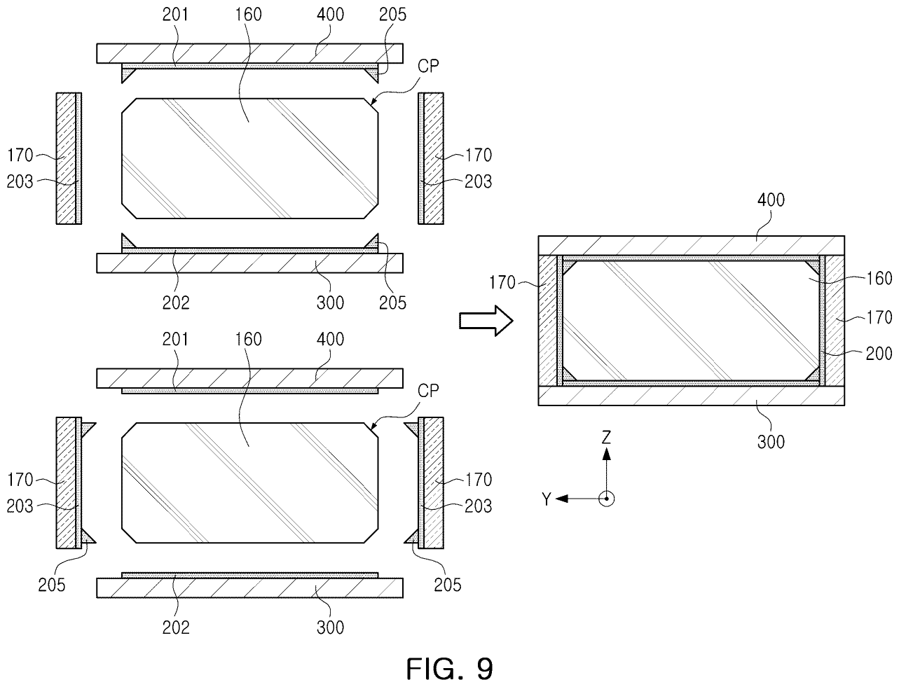

FIG. 9 is a cross-sectional view schematically illustrating the assembly of a sealing portion according to another embodiment.

Since the center cover 160 is coupled to the side covers 170 on both sides and coupled to the upper cover 400 and the lower cover 300 on the upper and lower sides, respectively, assembly may be difficult due to minor tolerances during the assembly process. For example, when the lower cover 300 is assembled last while the side cover 170 and the upper cover 400 are coupled to the center cover 160, even if it is provided as in FIG. 8, the assembly of the lower cover 300 may become difficult depending on the thickness of the sealing portion 200, or even if assembled, stress may be concentrated only on the lower cover 300, which may deteriorate the durability of the battery module 10.

Accordingly, according to another embodiment of the present disclosure, a chamfer component 205 may be further included, in which a chamfer cp is formed at the corner of the center cover 160 and a plurality of sealing components are provided in a shape corresponding to the chamfer cp. The chamfer component 205 may be provided in at least one of the plurality of sealing components 201, 202 and 203.

Among the upper drawings of FIG. 9, the left drawing is a drawing illustrating that the third component 203 is provided with the chamfer component 205, and among the upper drawings of FIG. 9, the right drawing is a drawing illustrating that the first and second components 201 and 202 are provided with the chamfer components 205.

Through this structure, referring to the lower drawing of FIG. 9, the gap between the center cover 160 on which the chamfer cp is formed and the adjacent cover members (side cover; 170, upper cover; 400, lower cover; 300) may be filled. As a result, the assembly reliability when assembling the adjacent cover members described above to the center cover 160 may be further improved.

Meanwhile, the embodiments described above in FIGS. 8 and 9 are described based on the fact that a plurality of sealing components 201, 202 and 203 are provided on the cover members (side cover; 170, upper cover; 400, lower cover; 300) adjacent to the center cover 160, respectively, and the cover members adjacent to the center cover 160 are combined with the center cover 160 so that the first to third components 201, 202 and 203 form the sealing portion 200.

However, the present disclosure is not limited thereto, and the sealing portion 200 may be formed on one or more of the protective covers 150, 160 and 170.

For example, unlike the drawing, a plurality of sealing components may be provided on the cover members (end cover; 150, upper cover; 400, lower cover; 300) adjacent to the side cover 170, respectively, and when the cover members adjacent to the side cover 170 are combined with the side cover 170, the plurality of sealing components may form a sealing portion 200.

For example, in the present disclosure, the sealing portion 200 may be provided on at least one of the protective covers 150, 160 and 170, and the sealing portion 200 may be formed when adjacent cover members provided with a plurality of sealing components of the battery module 10 are assembled with each other.

As set forth above, according to an embodiment, a battery module in which a fire occurring in a battery module may be delayed or minimized from spreading to an adjacent battery module may be provided.

According to an embodiment, a battery module may be provided in which a fire occurring in one sub-module may be delayed or minimized from spreading to an adjacent sub-module.

Only specific examples of implementations of certain embodiments are described. Variations, improvements and enhancements of the disclosed embodiments and other embodiments may be made based on the disclosure of this patent document. In the above-described embodiments, some components may be deleted and implemented, and respective embodiments may be implemented in combination with each other.

The contents described above are merely examples of applying the principles of the present disclosure, and other configurations may be further included without departing from the scope of the present disclosure.

What is claimed is:

1. A battery module comprising:
a first sub-module and a second sub-module respectively including a cell assembly having a plurality of battery cells and a protective cover accommodating at least a portion of the cell assembly, and facing each other in a first direction; and
a sealing portion provided on the protective cover and disposed on at least a portion of a peripheral surface of the protective cover,
wherein the sealing portion is formed by a plurality of sealing components separable based on the peripheral surface of the protective cover.

2. The battery module of claim 1, wherein the sealing portion is formed of a plurality of sealing components separable based on the peripheral surface of the protective cover.

3. The battery module of claim 2, wherein the protective cover includes:
a center cover disposed close to a cell assembly adjacent thereto;
an end cover facing the center cover; and
a side cover disposed parallel to a stacking direction of the plurality of battery cells, and
the sealing portion is provided to cover at least one of the center cover, the end cover, or the side cover.

4. The battery module of claim 3, further comprising an upper cover and a lower cover facing each other in a second direction perpendicular to the first direction, with the first sub-module and the second sub-module interposed therebetween, and respectively coupled to the protective cover,
wherein the upper cover and the lower cover are coupled to the end cover, the center cover, and the side cover and are disposed on the first sub-module and the second sub-module.

5. The battery module of claim 4, wherein the plurality of sealing components include:
a first component provided on the upper cover and disposed to face the center cover;
a second component provided on the lower cover and disposed to face the center cover; and
a third component provided on the side cover and disposed to face the center cover, and
the upper cover, the lower cover, and the side cover are coupled to the center cover.

6. The battery module of claim 5, wherein the first component, the second component, and the third component form a sealing portion disposed to cover a peripheral surface of the center cover when the upper cover.

7. The battery module of claim 6, wherein the end cover has a chamfer formed at each corner, and
the sealing portion includes a chamfer component provided in a shape corresponding to the chamfer.

8. The battery module of claim 7, wherein the chamfer component is provided on both ends of at least one of the first component, the second component, or the third component.

9. The battery module of claim 5, wherein the upper cover and the lower cover are provided with the first component and the second component disposed on portions thereof overlapping distal ends of one sides of the center cover and the side cover, based on the second direction, and
the side cover is provided with the third component provided on the distal end of one side thereof overlapping the center cover, based on the stacking direction.

10. The battery module of claim 1, wherein the protective cover is provided with a sealing groove accommodating at least a portion of the sealing portion.

11. A battery module comprising:
a first sub-module and a second sub-module respectively including a cell assembly in which a plurality of battery cells are stacked in a first direction, a side cover facing the cell assembly in the first direction, and a center cover facing the cell assembly in a second direction perpendicular to the first direction;
an upper cover and a lower cover disposed with the first sub-module and the second sub-module interposed therebetween in a direction perpendicular to the first direction and the second direction; and
a plurality of sealing components provided on the side cover, the upper cover and the lower cover to face the center cover,
wherein the plurality of sealing components form a sealing portion disposed to cover at least a portion of the center cover in a direction perpendicular to the first direction when the side cover, the upper cover, and the lower cover are coupled to the center cover.

12. The battery module of claim 11, wherein the sealing portion is disposed between a distal end of one side of the side cover, the upper cover, the lower cover, and the center cover.

13. The battery module of claim 12, wherein the center cover is disposed between the cell assembly of the first sub-module and the cell assembly of the second sub-module.
